(19) United States
(12) Patent Application Publication
(10) Pub. No.: US 2023/0137274 A1
(43) Pub. Date: May 4, 2023

(54) MOTORCYCLE FOOT REST ASSEMBLY HAVING ROTATABLE BODY

(71) Applicant: John Patrick O'Brien, Royal Oak, MI (US)

(72) Inventor: John Patrick O'Brien, Royal Oak, MI (US)

(21) Appl. No.: 17/969,218

(22) Filed: Oct. 19, 2022

Related U.S. Application Data
(60) Provisional application No. 63/272,780, filed on Oct. 28, 2021.

(51) Int. Cl. B62J 25/06; B62H 1/12

(52) U.S. Cl. CPC B62J 25/06; B62H 1/12

(57) ABSTRACT

A foot rest assembly for a motorcycle, where the foot rest assembly has a main body extending along a main body axis from a first end to a second end, a mounting bracket attached to the first end of the main body, and a rotatable body rotatably supported on the foot rest assembly. The main body is configured to support a foot of a user when the foot rest assembly is mounted to a motorcycle. The rotatable body, which may be one or more wheels and/or rollers, is configured to rotate along the ground when the rotatable body contacts the ground as a result of motorcycle operation. The rotatable body is configured to rotate around a rotary axis, which may be obliquely angled relative to the main body axis.

### TECHNICAL FIELD

This disclosure relates to foot rests for motorcycles and other ground passenger vehicles employing foot rests, including, floorboard and/or peg-type foot rests for motorcycles.

### BACKGROUND

Motorcycles have foot rests that a user can rest their feet on while operating the motorcycle. When a motorcycle turns, the motorcycle is often angled with respect to the roll axis—in some instances during a turn, the foot rest, which may extend laterally outward from the motorcycle, may contact the ground if the roll angle of the motorcycle is sufficiently large. When the foot rest contacts the ground, the driver or operator may lose control and potentially crash. And, even in instances where no crash occurs, the friction between the foot rest and the ground slows down the motorcycle and causes wear to the foot rest.

### SUMMARY

According to a first aspect of the disclosure, there is provided a foot rest assembly for a motorcycle, including a main body extending from a first end to a second end, a mounting bracket attached to the first end of the main body, and a rotatable body rotatably supported on the motorcycle foot rest assembly. The main body is configured to support a foot of a user when the foot rest assembly is mounted to a motorcycle. The rotatable body is configured to rotate when the rotatable body contacts the ground as a result of motorcycle operation.

According to a second aspect of the disclosure, there is provided a foot rest assembly for a motorcycle, including a main body extending along a main body axis from a first end to a second end, a mounting bracket attached to the first end of the main body, and a rotatable body rotatably supported on the motorcycle foot rest assembly and configured to rotate around a rotary axis that is obliquely angled relative to the main body axis. The main body is configured to support a foot of a user when the foot rest assembly is mounted to a motorcycle. The rotatable body is configured to rotate along the ground when the rotatable body contacts the ground as a result of motorcycle operation.

According to a third aspect of the disclosure, there is provided a foot rest assembly for a motorcycle, including a main body extending along a main body axis from a first end to a second end, a mounting bracket attached to the first end of the main body, and one or more wheels and/or rollers rotatably supported on the motorcycle foot rest assembly and configured to rotate around a rotary axis that is obliquely angled relative to the main body axis. The main body is configured to support a foot of a user when the foot rest assembly is mounted to a motorcycle. The rotatable body is configured to rotate along the ground when the rotatable body contacts the ground as a result of motorcycle operation.

According to various embodiments, the foot rest assembly according to the first aspect, the second aspect, and/or the third aspect may further include any one of the following features or any technically-feasible combination of some or all of the following features:
the main body includes a cylindrically- or rod- shaped portion that extends axially from the first end to the second end;
the main body includes a planar top surface configured to support the foot of the user;
the mounting bracket is integrally formed with the main body;
the rotatable body is a wheel that is rotatably supported on an axis of the main body;
the wheel is comprised of a polymeric material;
the wheel is comprised of a rubber material;
the rotatable body is a roller that is rotatably supported on a rotary axis of the main body;
the rotatable body is configured to rotate about a rotary axis, and wherein the rotary axis is obliquely angled relative to an axial direction of the main body that extends from the first end to the second end;
the oblique angle between the rotary axis and the axial direction of the main body is between 15° and 75°;
a rotatable body extension that extends from the second end of the main body, wherein the rotatable body is rotatably supported by the rotatable body extension;
the rotatable body extension extends from a first end, which is attached to the second end of the main body, to a second end along a rotatable body extension axis, and wherein the rotatable body extension axis is angled relative to a main body axis that extends from the first end of the main body to the second end of the main body;
the rotatable body extension includes a bore at the second end of the rotatable body extension, and wherein the bore is configured to rotatably support an axle;
the rotatable body is configured to rotate about a rotary axis, and wherein the rotary axis is substantially orthogonal to the rotatable body extension axis;
the rotatable body extension includes a shock absorber that extends substantially parallel to the rotatable body extension axis;
the rotatable body is removable from the motorcycle foot rest assembly so that the rotatable body is replaceable by a second rotatable body;
the main body has a floorboard configuration and includes a top surface configured to receive a sole of the foot of the user;
the mounting bracket is attached to the main body with screws and/bolts.

According to a fourth aspect of the disclosure, there is provided a passenger vehicle having the foot rest assembly according to the first aspect, the second aspect, the third aspect, and/or any technically-feasible combination of those aspects or features listed above. According to various embodiments based on this fourth aspect, the foot rest assembly is a first foot rest assembly, and the passenger vehicle further includes a second foot rest assembly having a main body extending from a first end to a second end, a mounting bracket attached to the first end of the main body of the second foot rest assembly, and a rotatable body rotatably supported on the second foot rest assembly. The main body is configured to support a foot of a user when the second foot rest assembly is mounted to the passenger vehicle. The rotatable body is configured to rotate when the rotatable body contacts the ground as a result of passenger vehicle operation. According to some embodiments, the passenger vehicle of the fourth aspect is a motorcycle having a driver's seat for a driver, and wherein the first foot rest assembly and the second foot rest assembly are each configured to receive a different foot of the driver when seated in the driver's seat.

According to other aspects of the disclosure, the foot rest assembly provided herein, which may be configured for use with a motorcycle or other passenger vehicle, for example, may further have any of the features described herein or any technically-feasible combination of some or all of the features described herein.

### BRIEF DESCRIPTION OF THE DRAWINGS

Preferred exemplary embodiments will hereinafter be described in conjunction with the appended drawings, wherein like designations denote like elements, and wherein:

FIG. 1 is a front view of a motorcycle, namely a tire of the motorcycle and a left foot rest assembly and a right foot rest assembly, according to a first embodiment;

FIG. 2 is a front view of the motorcycle of FIG. 1, when the motorcycle is rotated about a roll axis such that a rotatable body of the left foot rest assembly contacts the ground;

FIG. 3 is a perspective view of a bottom side and a first peripheral side of the left foot rest assembly of FIGS. 1-2, according to the first embodiment;

FIG. 4 is a perspective view of the bottom side and a second peripheral side of the left foot rest assembly of FIGS. 1-2, according to the first embodiment;

FIG. 5 is a sectional view of the foot rest assembly of FIGS. 1-2 taken along a main body axis, according to the first embodiment;

FIG. 6 is a detailed portion of the sectional view of the foot rest assembly of FIG. 5 taken along the main body axis, according to the second embodiment;

FIG. 7 is a perspective view of a bottom side and a first peripheral side of a foot rest assembly, according to the second embodiment;

FIG. 8 is a perspective view of the bottom side and a second peripheral side of the foot rest assembly of FIG. 7, according to the second embodiment;

FIG. 9 is a sectional view of the foot rest assembly of FIG. 7 taken along a main body axis, according to the second embodiment; and

FIG. 10 is a detailed portion of the sectional view of the foot rest assembly of FIG. 9 taken along the main body axis, according to the second embodiment.

### DETAILED DESCRIPTION

The foot rest assembly described herein includes a main body (e.g., a foot peg or a floorboard) connected to the motorcycle via a mounting bracket at a first end thereof and a rotatable body connected to a second end of the main body, and is so configured such that, when the rotatable body contacts the ground, such as the result of leaning the motorcycle during a turn, the rotatable body rotates along the ground. As discussed above, conventional foot rest assemblies for motorcycles typically include an elongated foot rest that extends laterally outward from the motorcycle, and may a foot peg configuration or a floorboard configuration. An outer-most end of such conventional foot rest assemblies may contact the ground during a maneuver of the motorcycle, such as leaning during a sharp turn. This contact between the end of the foot rest assembly and the ground may cause the motorcycle to jerk, may cause drag on the motorcycle due to friction between the ground and foot rest assembly, and/or may otherwise cause the operator to have less control (and potentially even lose control) of the motorcycle. According to at least some embodiments, the rotatable body of the foot rest assembly is provided at an outside lateral end of the foot rest assembly and is configured so that, when the foot rest assembly comes into contact with the ground, such as the result of leaning the motorcycle during a turn, the rotatable body (e.g., wheel, roller) contacts the ground first and rotates along the ground thereby reducing frictional forces between the foot rest assembly and the ground (and, thus, reducing wear on the foot rest assembly) as well as reducing the chances that the operator loses control of the motorcycle.

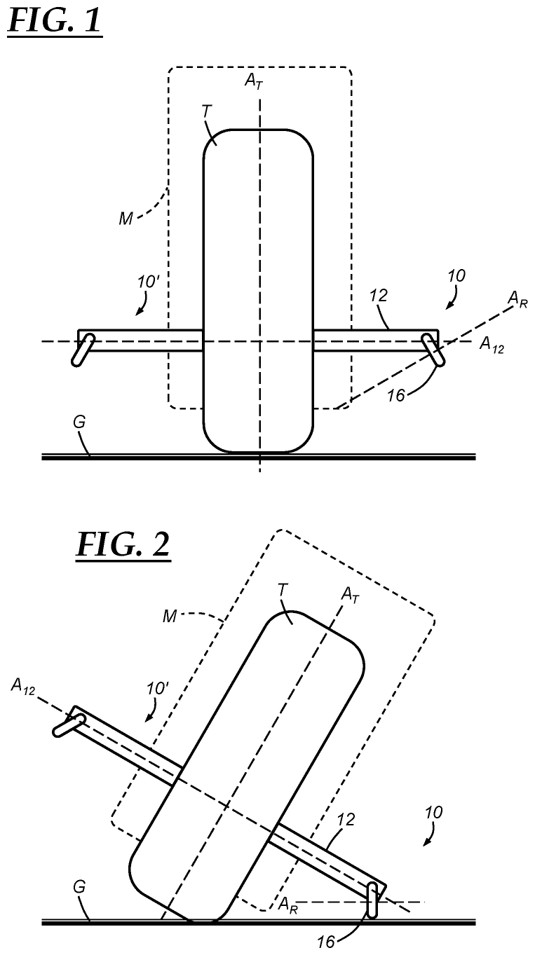

With reference to FIGS. 1-6, there is shown a foot rest assembly 10 for a motorcycle according to a first embodiment. The foot rest assembly 10 is described herein as being configured for use with a motorcycle M; however, it should be appreciated that, according to other embodiments, the foot rest assembly may be configured for use with other vehicles, such as bicycles, scooters, and mopeds. For example, in one embodiment where the vehicle is a scooter or moped, the foot rest assembly 10 may be or include a scooter or moped foot stand or peg that allow a user to rest their feet or stand. The discussion below is provided with respect to a single foot rest assembly 10; however, as shown in FIGS. 1-2, two foot rest assemblies 10,10′ may be provided and installed on the motorcycle M. The foot rest assembly 10′ is the same as the foot rest assembly 10, except that the foot rest assembly 10 is configured to be installed on the left side of the motorcycle M whereas the foot rest assembly 10′ is configured to be installed on the right side of the motorcycle M. In at least one embodiment, the right-sided foot rest assembly 10′ is a mirror image of the left-sided foot rest assembly 10. It should be appreciated that the foot rest assemblies of the depicted embodiments are exemplary; according to various embodiments, the foot rest assembly may include various different configurations and/or features, such as heel rests or stops, for example.

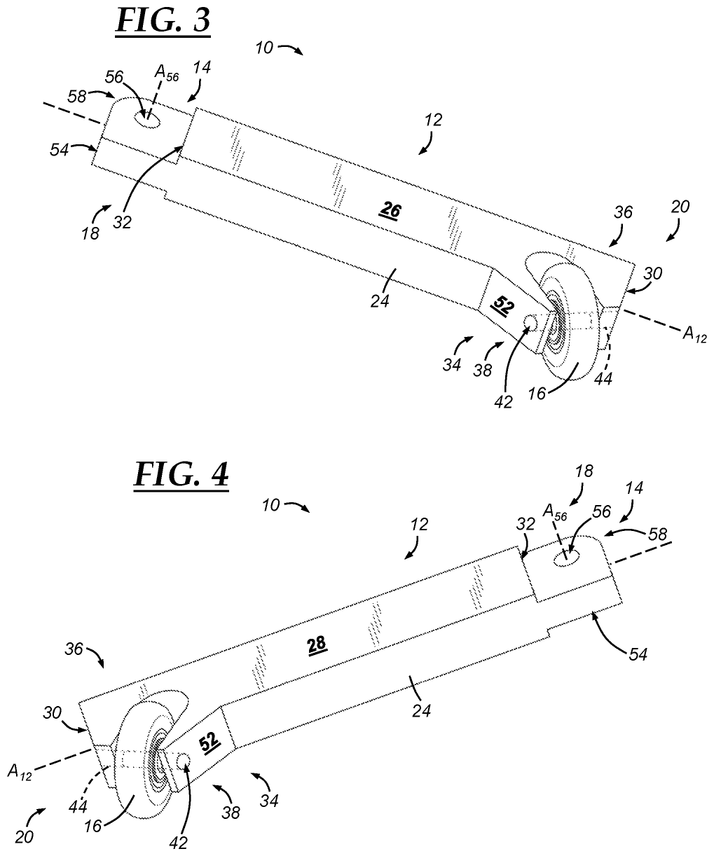

With reference to FIGS. 3-6, there is shown the foot rest assembly 10 of FIG. 1, which generally includes a main body 12, a mounting bracket or portion 14 (referred to herein as a “mounting bracket”), and a rotatable body 16. The main body 12 extends from a first end 18 to a second end 20 along a main body axis Al2 and is configured to support the left foot of a user when the foot rest assembly 10 is mounted to a vehicle. The mounting bracket 14 is connected to the first end 18 of the main body 12 and, as depicted in FIGS. 3-5, is integrally formed therewith so that the main body 12 and the mounting bracket 14 are of a unitary construction. However, it should be appreciated that, in other embodiments, the main body 12 and the mounting bracket 14 may be provided as separate pieces that are attached to one another, such as through use of rivets, screws, bolts, welds, adhesives, etc.

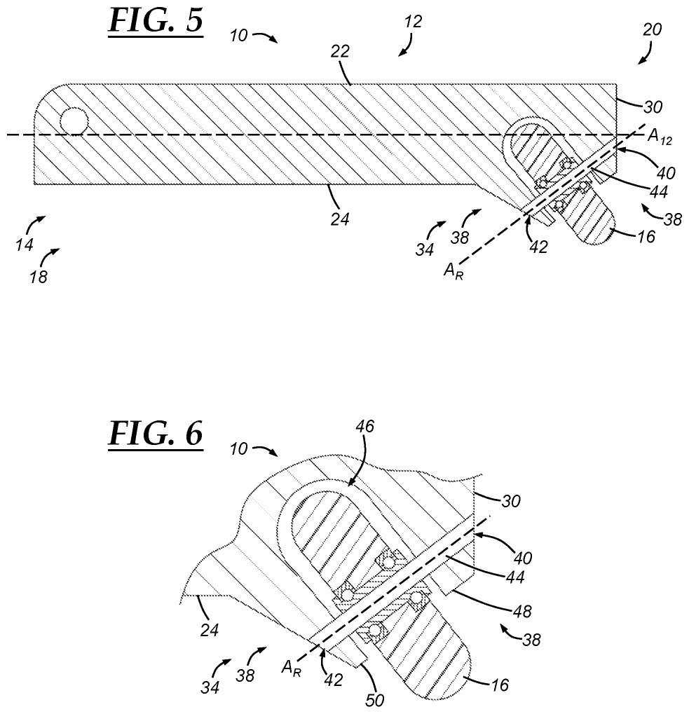

The main body 12 is rectangular in cross-section and is shaped as an elongated cuboid or rectangular bar. However, in other embodiments, the cross-section of the main body 12 could be other geometric shapes including but not limited to circular, oval, or flat. The main body 12 includes a top surface 22 (FIG. 5), upon which a user of the motorcycle M may rest their foot. The top surface 22 extends from the first end 18 of the main body 12 to the second end 20 of the main body 12 and is planar. In some embodiments, the top surface 22 may include gripping means, such as anti-slip or grip tapes, non-slip coatings, a knurled texture or surface (or other textured surface), etc. In one embodiment, such as one where the foot rest assembly is used for off-road motorcycles or bikes, the main body 12 may be a perforated/serrated grating, such as those used for off-road motorcycles or bikes, and/or may include upwardly-extending protrusions or protuberances.

In embodiments, the foot rest assembly may use a floorboard configuration in which a floorboard configured to receive a sole of a foot is provided. The floorboard may be a separate piece that is connected to the main body 12 or may be integral with the main body 12. In other embodiments, however, such as the illustrated embodiment, the foot rest assembly 10 has a foot peg configuration in which the main body is elongated in a rod-like manner.

The main body 12 also includes a bottom surface 24, as well as two side surfaces 26,28, which are also referred to herein as a first side surface 26 and a second side surface 28. The bottom surface 24 is planar, extends from the first end 18 of the main body 12 to the second end 20 of the main body, opposes the top surface 22, and is parallel to the top surface 22. The first side surface 26 is planar, extends from the first end 18 of the main body 12 to the second end 20 of the main body 12, opposes the second side surface 28, and is parallel to the second side surface 28. Likewise, the second side surface 28 is planar and extends from the first end 18 of the main body 12 to the second end 20 of the main body 12. The main body 12 further includes an outward-facing end surface 30 and an inward-facing end surface 32. The outward-facing end surface 30 extends between a peripheral edge of the top surface 22, the first side surface 26, and the second side surface 28. The inward-facing end surface 32 extends between a peripheral edge of the top surface 22, the first side surface 26, the second side surface 28, and the bottom surface 24. Each of the outward-facing end surface 30 and the inward-facing end surface 32 is planar and is shaped as a rectangle. In other embodiments, the main body 12 is cylindrically- or rod-shaped and includes an outer cylindrical surface that is defined by the main body axis A₁₂, which extends from the first end 18 toward the second end 20. In such an embodiment, the user may rest their foot on a top or upward-facing portion of the outer cylindrical surface.

As shown in FIGS. 3-5, at the first end 18, the main body 12 is attached to the mounting bracket 14 and, at the second end 20, the main body 12 includes a rotatable body fixing portion 34 that rotatably fixes the rotatable body 16 to, and supports the rotatable body 16 on, the foot rest assembly 10 and, in particular, the main body 12. The rotatable body fixing potion 34 includes an upper housing portion 36 and a lower housing portion 38. Furthermore, the rotatable body fixing potion 34 includes a first bore 40 that is disposed within the upper housing portion 36 and a second bore 42 that is disposed within the lower housing portion 38, where each of the first bore 40 and the second bore 42 is configured to receive a portion of an axle 44, which may be constructed from or as a pin or screw. The axle 44 rotatably supports the rotatable body 16 such that the rotatable body 16 rotates around a rotary axis A_{R} (FIGS. 1-2, 5-6) defined by the axle 44. The upper housing portion 36 and the lower housing portion 38 define, at least in part, a rotatable body space 46 (FIG. 6) that is configured so as to permit the rotatable body 16 to rotate freely when rotatably supported by the axle 44 or other portion of the foot rest assembly 10. In some embodiments, the axle 44 is removeable so that the rotatable body or wheel 16 is removeable and replaceable by another wheel, which may be particularly useful where the rotatable body 16 experiences heavy wear.

The upper housing portion 36 of the rotatable body fixing portion 34 includes an angled surface 48 (FIG. 6), which is parallel or substantially parallel to the rotary axis A_{R}. Likewise, the lower housing portion 38 of the rotatable body fixing portion 34 includes a first angled surface 50 (FIG. 6), which is parallel or substantially parallel to the rotary axis A_{R}. The lower housing portion 38 further includes a second angled surface 52 that is extends between the first angled surface 50, the bottom surface 24 of the main body 12, the first side surface 26 of the main body 12, and the second side surface 28 of the main body 12.

The rotatable body 16 is rotatably supported on the foot rest assembly 10 and, in particular, by the axle 44 of the main body 12. The rotatable body 16 is illustrated as a wheel, but it should be appreciated that other rotatable bodies may be used. Such other examples of rotatable bodies include rollers, continuous tracks, roller balls or bearings configured to engage a surface (e.g., rollerball guides having a captured roller ball), etc. And, it should be appreciated that, in some embodiments, multiple rotatable bodies, such as multiple wheels or rollers, may be used. For example, in one embodiment, two wheels, each of which constitutes a rotatable body, is rotatably supported by the axle 44. The rotatable body 16 may be comprised of a polymeric material and, in a particular embodiment, a rubber material, such as a hard synthetic rubber. For example, the rotating body 16 may be a polyurethane wheel that is between 20 mm and 100 mm. In some embodiments, the Shore A hardness of the rotatable body 16 is at least 90 and, in one embodiment, at least 97. In some embodiments, the Shore D hardness of the rotatable body 16 is at least 50 and, in one embodiment, at least 65.

The mounting bracket 14 includes a plate 54 and a bore 56 that is disposed within the plate 54. The plate 54 is generally rectangularly-shaped (or cuboid-shaped), but includes a rounded edge 58. The plate 54 is integrally formed with the main body 12 and is connected to the main body 12 at the first end 18. The plate 54 projects axially, with respect to the main body axis A₁₂, from the inward-facing surface 32 of the main body 12. The bore 56 is configured to receive a mounting pin or other implement (not shown) that fixes or holds the foot rest assembly 10 to the motorcycle. In at least one embodiment, the mounting pin may be attached at each end to the motorcycle, such as to a frame component thereof, and the mounting pin passes through the bore 56. In one embodiment, the main body 12 of the foot rest assembly 10 is rotatably coupled or fixed to, and rotatably supported on, the motorcycle by way of the mounting pin passing through the bore 56. This enables the foot rest assembly 10 to be rotated about a mounting bore axis A₅₆ so that, for example, the foot rest assembly 10 may be rotated/folded upward so that the assembly 10 is in a stowed position and then rotated/folded downward from the stowed position into an extended or deployed position, such as that which is shown in FIGS. 1-2. In some embodiments, the foot rest assembly 10 may be locked or held in the stowed position and/or the deployed position by one or more locking mechanisms (e.g., a pin and slot configured so that, when the pin is within the slot, the foot rest assembly 10 is prevented from rotating). In one embodiment, the foot rest assembly 10 is not locked by a locking mechanism within the deployed position, but, rather, the foot rest assembly 10 is held down in the deployed position by gravity and/or the weight of the user's foot. In such embodiments, when the foot rest assembly 10 contacts the ground G, namely when the rotatable body 16 contacts the ground G, the impact may cause the foot rest assembly 10 to rotate upwardly about the mounting bore axis A₅₆ thereby dissipating the resulting force when the foot rest assembly 10 strikes the ground G. In other embodiments, the foot rest assembly 10 is held fixedly to the motorcycle such that it is prevented from moving relative to the motorcycle.

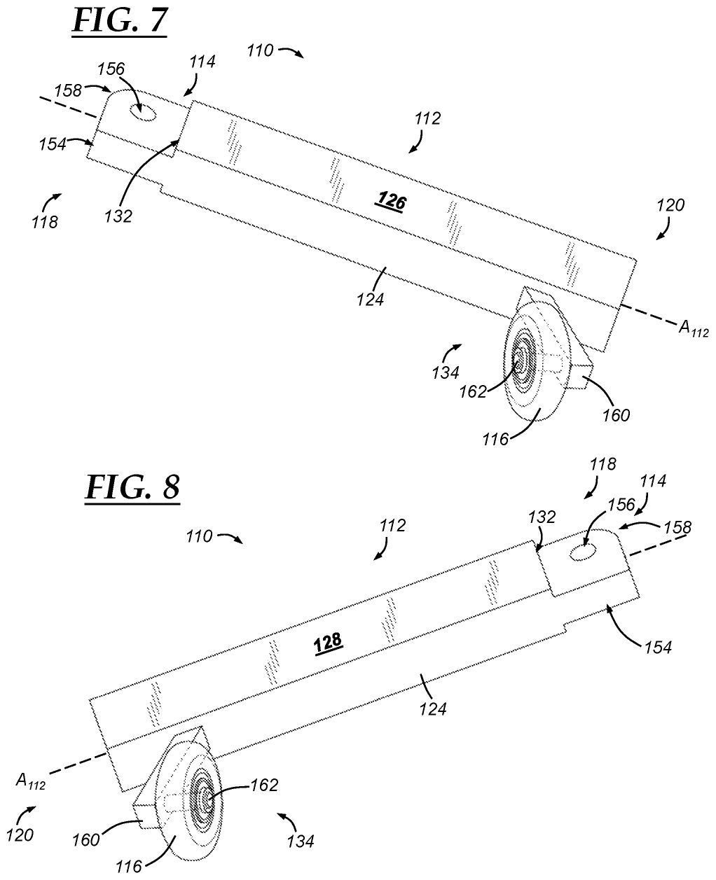

With reference to FIGS. 7-10, there is shown a foot rest assembly 110 for a motorcycle according to a second embodiment. The foot rest assembly 110 may be installed onto a motorcycle, such as the motorcycle M, and may operate in a manner similar to that of the foot rest assembly 10 described above. Additionally, in some embodiments, two foot rest assemblies 110 may be provided, including a left-sided foot rest assembly and a right-sided foot rest assembly, each of which is a mirror image of the other. Of course, according to various embodiments, the foot rest assembly 110 may be used in conjunction with other vehicles.

The foot rest assembly 110 includes a main body 112, a mounting bracket or portion 114, and a rotatable body 116. The foot rest assembly 110 includes certain features that are the same as or similar to those of the foot rest assembly 10 described above and, to the extent that discussion is not inconsistent with the discussion below, that discussion above is hereby attributed to the foot rest assembly 110. Moreover, the reference numerals of like or analogous components of the foot rest assembly 10 and the foot rest assembly 110 are indicated by like numerals—for example, the mounting bracket 114 of the foot rest assembly 110 is analogous to the mounting bracket 14 of the foot rest assembly 10 and that discussion above relating to the mounting bracket 14 is hereby attributed to the mounting bracket 114. A difference between the foot rest assembly 10 and the foot rest assembly 110 is that the foot rest assembly 110 includes a rotatable body extension 160 that extends away from the main body 112 and that rotatable supports the rotatable body 116. Other similarities and differences between the foot rest assembly 10 and the foot rest assembly 110 will be appreciated by those skilled in the art in light of the discussion below and associated figures.

The mounting bracket 114 includes a plate 154 having a bore 156, and the plate 154 includes a rounded edge 158. The mounting bracket 114 is analogous to the mounting bracket 14 of the foot rest assembly 10 and that discussion is hereby attributed to the mounting bracket 114 of the foot rest assembly 110.

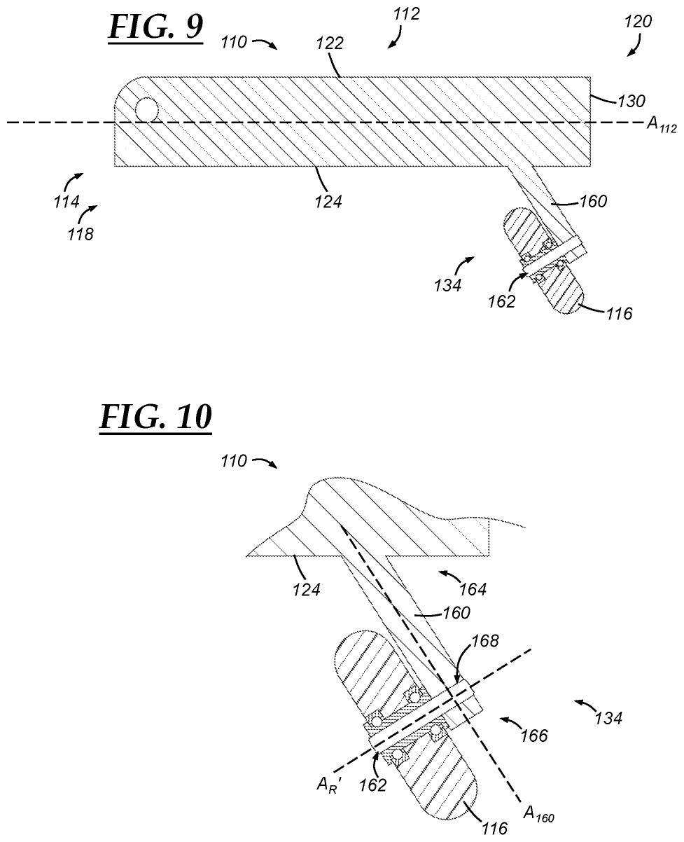

The main body 112 extends from a first end 118 to a second end 120 along a main body axis A 112, is rectangular in cross-section, and is shaped as an elongated cuboid or rectangular bar. However, in other embodiments, the cross-section of the main body 112 could be other geometric shapes including but not limited to circular, oval or flat. The main body 112 includes a top surface 122 (FIG. 9), upon which a user of the motorcycle may rest their foot, as well as a bottom surface 124, two side surfaces 126,128, an outward-facing end surface 130 (FIG. 9), and an inward-facing end surface 132. The main body 112 also includes a rotatable body fixing portion 134, which includes an axle 162 and the rotatable body extension 160 that extends from a first end 164 to a second end 166 along a rotatable body extension axis A₁₆₀ (FIG. 10). In one embodiment, the rotatable body extension 160 is disposed in a manner similar to a wear peg, and projects away from the bottom surface 124 of the main body 112 along the rotatable body extension axis A₁₆₀. The rotatable body extension axis A₁₆₀ is disposed at a non-zero angle relative to the main body axis A₁₁₂ and may be disposed at 20°-70° relative thereto (i.e., the angle between the rotatable body extension axis A₁₆₀ and the main body axis A₁₁₂ is between 20°-70°) or, more particularly, at 30°-60° relative thereto.

The rotatable body extension 160 is shaped as an elongated cuboid or rectangular bar; however, it should be appreciated that the rotatable body extension 160 may be cylindrically- or rod-shaped, or otherwise configured as another suitable shape. The rotatable body extension 160 is integrally formed with the main body 112; however, it should be appreciated that the rotatable body extension 160 and the main body 112 may be provided as separate pieces that are connected or attached to one another, such as through use of rivets, screws, bolts, welds, adhesives, etc. The rotatable body extension 160 includes a bore 168 at the second end 166. The bore 168 is configured to receive the axle 162 so that the rotatable body 116 is thereby rotatably coupled to, or supported on, the rotatable body extension 160 and the main body 112. The bore 168 may pass entirely through the rotatable body extension 160 or may be formed as a cavity or well that does not pass through the front side of the rotatable body extension 160.

The axle 162 may be constructed from or as a pin or screw and is used to rotatably support the rotatable body 116 such that the rotatable body 116 rotates around a rotary axis A_{R} (FIG. 10) defined by the axle 162. The rotary axis A_{R}′ may be parallel to the rotatable body extension axis A₁₆₀, as shown in the illustrated embodiment of FIGS. 7-10. The rotary axis A_{R}′ is substantially orthogonal to the rotatable body extension axis. As used herein, “substantially orthogonal” means orthogonal within +/−10°. The axle 162 projects away from an inward-facing surface of the rotatable body extension 160 and inwardly relative to the motorcycle when the foot rest assembly 110 is mounted thereto. However, in other embodiments, the axle 162 and the rotatable body 116 may project away from an outward-facing surface of the rotatable body extension 160 and outwardly relative to the motorcycle when the foot rest assembly 110 is mounted thereto.

In one embodiment, the rotatable body extension 160 includes a shock absorber (not shown), such as a hydraulic shock absorber, a mono-tube shock absorber, a twin-tube shock absorber, etc. The shock absorber may include a piston or extension that extends parallel to the rotatable body extension axis A₁₆₀ as well as a spring and may be configured to dampen and absorb shock impulses generated as a result of the rotatable body 116 contacting the ground G, such as during motorcycle operation. In such embodiments, dampening or absorption of such shock impulses, which may occur while driving the motorcycle around a turn, may reduce the amount of jerk or undesirable movement of the motorcycle and may reduce the likelihood of an accident and/or improve user comfort during maneuvers when the rotatable body 116 contacts the ground G.

In at least some embodiments, including in the illustrated embodiments, the rotary axis A_{R},A_{R}′ is disposed at a non-zero angle relative to the relative to the main body axis A₁₂,A₁₁₂ (or axial direction of the main body 12,112). In one embodiment, this angle is between 15° to 75° and, in a particular embodiment, between 30° to 60°. With reference to FIGS. 1-2, when the motorcycle enters a turn, the motorcycle oftentimes experiences roll and, depending on how much roll the motorcycle experiences, the foot rest assembly 10 may contact the ground G (i.e., the surface over which the motorcycle is travelling or resting upon). It should be appreciated that, while the discussion below and FIGS. 1-2 are provided with respect to the foot rest assembly 10, the teachings of said discussion and figures also applies to the foot rest assembly 110 to the extent said teachings is not inconsistent with the express teachings of the foot rest assembly 110 herein.

As used herein, the roll angle at which the foot rest assembly 10,110 first contacts the ground G during a turn is referred to as the ground-contact roll angle. The ground-contact roll angle may vary depending on the configuration and arrangement of components of the motorcycle and/or the foot rest assembly 10,110. In some embodiments, the foot rest assembly 10,110 is configured so that the rotary axis A_{R},A_{R}′, around which the rotatable body 16,116 rotates, is parallel (or substantially parallel—i.e., within 20°) to the ground G when the motorcycle is disposed at the ground-contact roll angle or when the rotatable body 16,116 contacts the ground G. Thus, in instances where the rotatable body 16,116 contacts the ground G as a result of the motorcycle being disposed at the ground-contact roll angle (or a greater angle) (e.g., as a result of a turn), the rotatable body 16,116 travels straight along the ground as the rotary axis A_{R},A_{R}′ is parallel (or substantially parallel) to the ground G. When the motorcycle is balanced side-to-side (with zero roll, such as is shown in FIG. 1, where the front tire axis A_{T} is perpendicular to the ground G), the rotary axis A_{R} is obliquely angled relative to the ground G., at least according to some embodiments. As used herein, “obliquely angled” means angled 10° or more. Additionally, at least in some embodiments, the rotary axis A_{R} is obliquely angled relative to the main body axis A₁₂.

In some embodiments, the foot rest assembly 10,110 may be configured so that the angle of the rotary axis A_{R},A_{R}′ relative to the main body axis A₁₂,A₁₁₂ of the main body 12,112 is set based on a length of the foot rest assembly 10,110 (or portion thereof, such as the main body 12,112), which may be taken along the main body axis A₁₂,A₁₁₂ of the main body 12,112 from an end of the mounting bracket 14,114 toward an outside end of the main body 12,112. Additionally, in some embodiments, the angle of the rotary axis A_{R},A_{R}′ may be set based on a height of the foot rest assembly 10,110 when installed on the motorcycle, such as a height from the ground to a bottom edge of the second end 20,120 of the main body 12,112 or to a bottom edge of the rotatable body 16,116. Such a calculation for determining a preferred or desired angle at which the rotary axis A_{R},A_{R}′ is disposed relative to the main body axis A₁₂,A₁₁₂ (or axial direction of the main body 12,112) may be determined based on a variety of factors. In at least some embodiments, such a determination takes into consideration various known factors, such as the dimensionality of the foot rest assembly 10,110 and the motorcycle M, such as the angle between the longitudinal axis of the front tire T of the motorcycle A_{T} (FIGS. 1-2) and the main body axis 12,112. In at least some embodiments, the foot rest assembly 10,110 is configured to be mounted to the motorcycle so that the main body axis 12,112 is perpendicular or substantially perpendicular (i.e., perpendicular within +/−20°) of the front tire axis A_{T}.

In at least some embodiments, the angle at which the rotary axis A_{R},A_{R}′ is disposed relative to the main body axis A₁₂,A₁₁₂ (or axial direction of the main body 12,112) is based on both a length of the foot rest assembly 10,110 (e.g., a distance representing the extent to which the rotatable body 16,116 is disposed as measured along the main body axis A₁₂,A₁₁₂) and a height or elevation of the foot rest assembly 10,110 when installed on the motorcycle (e.g., a distance between a bottom-most surface of the rotatable body 16,116 and the ground G). Such factors affect the ground-contact roll angle of the motorcycle having the foot rest assembly 10,110, which may be used to determine the angle at which the rotary axis A_{R},A_{R}′ is disposed. Of course, it should be appreciated that other factors may be used to set the angle at which the rotary axis A_{R} is disposed relative to the main body axis A₁₂,A₁₁₂. Also, it should be appreciated that other points of reference and/or dimensions of the motorcycle and/or foot rest assembly 10,110 may be used as a part of determining the angle at which the rotary axis A_{R},A_{R}′ is disposed relative to the main body axis A₁₂,A₁₁₂ (or axial direction of the main body 12,112). In some embodiments, one or more standard, empirically-derived, conventional, or typical dimensions, such as a typical or conventional height or elevation of the foot rest assembly, are determined and used as a basis for determining the angle at which the rotary axis A_{R},A_{R}′ is disposed relative to the main body axis A₁₂,A₁₁₂ (or axial direction of the main body 12,112).

According to some embodiments, the rotatable body 16,116 is replaceable, such as when the rotatable body 16,116 becomes worn down, for example. Conventional foot rest assemblies for motorcycles may be removed from the motorcycle and replaced with a new foot rest assembly, such as when the outer peripheral edge of the foot rest assembly becomes worn down from use. While such removable foot rest assemblies are replaceable, the entire foot rest assembly, or at least the main body, must be replaced even though the primary wear occurs at the outer peripheral edge. According to at least one embodiment, the foot rest assembly 10,110 is configured so that the rotatable body 16,116 is removable from the foot rest assembly 10,110, which allows for only the rotatable body (or bodies) to be replaced by another rotatable body (or bodies). Thus, according to such embodiments, the entire foot rest assembly or substantial portion thereof need not be replaced, but only the rotatable body (or bodies), which is the part most likely to experience the most wear as it may contact the ground during turns or other vehicle maneuvers. In one embodiment, the axle 34 is removable from the first bore 30 and the second bore 32 of the main body 12, and is likewise removable from the rotatable body 16, which then permits the rotatable body 16 from being removed from the foot rest assembly 10. The axle 34 may then be inserted into another rotatable body, and then inserted into the first bore 30 and the second bore 32 of the main body 12. Likewise, in one embodiment, the axle 162 is removable from the bore 168 of the rotatable body extension 160, and is likewise removable from the rotatable body 116, which then permits the rotatable body 116 from being removed from the foot rest assembly 110. The axle 162 may then be inserted into another rotatable body, and then inserted into the bore 168 of the rotatable body extension 160.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.” All ranges herein are inclusive unless stated otherwise.

1. A motorcycle foot rest assembly, comprising:
a main body extending from a first end to a second end, wherein the main body is configured to support a foot of a user when the motorcycle foot rest assembly is mounted to a motorcycle;
a mounting bracket attached to the first end of the main body; and
a rotatable body rotatably supported on the motorcycle foot rest assembly, wherein the rotatable body is configured to rotate when the rotatable body contacts the ground as a result of motorcycle operation.

2. The motorcycle foot rest assembly of claim 1, wherein the main body includes a cylindrically- or rod- shaped portion that extends axially from the first end to the second end.

3. The motorcycle foot rest assembly of claim 1, wherein the main body includes a planar top surface configured to support the foot of the user.

4. The motorcycle foot rest assembly of claim 1, wherein the mounting bracket is integrally formed with the main body.

5. The motorcycle foot rest assembly of claim 1, wherein the rotatable body is a wheel that is rotatably supported on an axis of the main body.

6. The motorcycle foot rest assembly of claim 5, wherein the wheel is comprised of a polymeric material.

7. The motorcycle foot rest assembly of claim 6, wherein the wheel is comprised of a rubber material.

8. The motorcycle foot rest assembly of claim 1, wherein the rotatable body is a roller that is rotatably supported on a rotary axis of the main body.

9. The motorcycle foot rest assembly of claim 1, wherein the rotatable body is configured to rotate about a rotary axis, and wherein the rotary axis is obliquely angled relative to an axial direction of the main body that extends from the first end to the second end.

10. The motorcycle foot rest assembly of claim 9, wherein the oblique angle between the rotary axis and the axial direction of the main body is between 15° and 75°.

11. The motorcycle foot rest assembly of claim 10, further comprising a rotatable body extension that extends from the second end of the main body, wherein the rotatable body is rotatably supported by the rotatable body extension.

12. The motorcycle foot rest assembly of claim 11, wherein the rotatable body extension extends from a first end, which is attached to the second end of the main body, to a second end along a rotatable body extension axis, and wherein the rotatable body extension axis is angled relative to a main body axis that extends from the first end of the main body to the second end of the main body.

13. The motorcycle foot rest assembly of claim 12, wherein the rotatable body extension includes a bore at the second end of the rotatable body extension, and wherein the bore is configured to rotatably support an axle.

14. The motorcycle foot rest assembly of claim 12, wherein the rotatable body is configured to rotate about a rotary axis, and wherein the rotary axis is substantially orthogonal to the rotatable body extension axis.

15. The motorcycle foot rest assembly of claim 12, wherein the rotatable body extension includes a shock absorber that extends substantially parallel to the rotatable body extension axis.

16. The motorcycle foot rest assembly of claim 1, wherein the rotatable body is removable from the motorcycle foot rest assembly so that the rotatable body is replaceable by a second rotatable body.

17. The motorcycle foot rest assembly of claim 1, wherein the main body has a floorboard configuration and includes a top surface configured to receive a sole of the foot of the user.

18. The motorcycle foot rest assembly of claim 1, wherein the mounting bracket is attached to the main body with screws and/bolts.

19. A motorcycle foot rest assembly, comprising:
a main body extending along a main body axis from a first end to a second end, the main body being configured to support a foot of a user when the motorcycle foot rest assembly is mounted to a motorcycle;
a mounting bracket attached to the first end of the main body; and
a rotatable body rotatably supported on the motorcycle foot rest assembly and configured to rotate around a rotary axis that is obliquely angled relative to the main body axis, wherein the rotatable body is configured to rotate along the ground when the rotatable body contacts the ground as a result of motorcycle operation.

20. A motorcycle foot rest assembly, comprising:
a main body extending along a main body axis from a first end to a second end, wherein the main body is configured to support a foot of a user when the motorcycle foot rest assembly is mounted to a motorcycle;
a mounting bracket attached to the first end of the main body; and
one or more wheels and/or rollers rotatably supported on the motorcycle foot rest assembly and configured to rotate around a rotary axis that is obliquely angled relative to the main body axis, wherein the rotatable body is configured to rotate along the ground when the rotatable body contacts the ground as a result of motorcycle operation.
